(19) United States
(12) Patent Application Publication
(10) Pub. No.: US 2026/0320515 A1
(43) Pub. Date: Oct. 15, 2026

(54) UNIFIED FRAMEWORK FOR OBJECT-BACKED ACTIONABLE TASKS ASSIGNED TO USERS

(71) Applicant: Meta Platforms Technologies, LLC, Menlo Park, CA (US)

(72) Inventor: Shenal Santhush Kotuwewatta, Bellevue, WA (US)

(73) Assignee: Meta Platforms Technologies, LLC, Menlo Park, CA (US)

(21) Appl. No.: 19/463,432

(22) Filed: Jan. 29, 2026

Related U.S. Application Data
(60) Provisional application No. 63/751,177, filed on Jan. 29, 2025.

(51) Int. Cl. G06Q 10/0631

(52) U.S. Cl. CPC G06Q 10/06311

(57) ABSTRACT

Systems and methods are described for unified framework for object-backed actionable tasks assigned to users. Example methods may include identifying, by one or more computer processors coupled to memory, a task type and a task field associated with the task type, generating a common abstract interface using the identified task type and task field, implementing aggregation queries in a framework, populating the aggregation queries, and providing access to the aggregation queries to an API consumed by the platform.

### CROSS-REFERENCE TO RELATED APPLICATION

This application claims the benefit of US Application No. 63/751,177, filed Jan.29, 2025, the entirety of which is incorporated by reference.

### TECHNICAL FIELD

The present disclosure generally relates to online platforms, and more particularly, to a unified framework for object-backed actionable tasks assigned to users.

### BACKGROUND

User-assigned tasks are a prevalent feature in various platforms designed for external users, including advertising and developer platforms. These tasks typically involve users completing specific actions within a set timeframe. The purpose of these tasks is to ensure that users meet certain operational requirements of the platform. By doing so, the platform can maintain its functionality and service quality.

Additionally, these tasks serve as a means to evaluate users’ eligibility for continued access to the platform. By assessing whether users can successfully complete the assigned tasks, the platform can determine if users are adhering to its standards and guidelines. This evaluation process helps maintain a high level of user engagement and ensures that the platform remains a reliable and efficient tool for its intended audience.

### SUMMARY

The subject disclosure is directed to a unified framework for object-backed actionable tasks assigned to users. The subject technology relies on a common interface shared by all tasks and an associated object type for each task, which are implemented in a number of steps.

### BRIEF DESCRIPTION OF THEDRAWINGS

To easily identify the discussion of any particular element or act, the most significant digit or digits in a reference number refer to the figure number in which that element is first introduced.

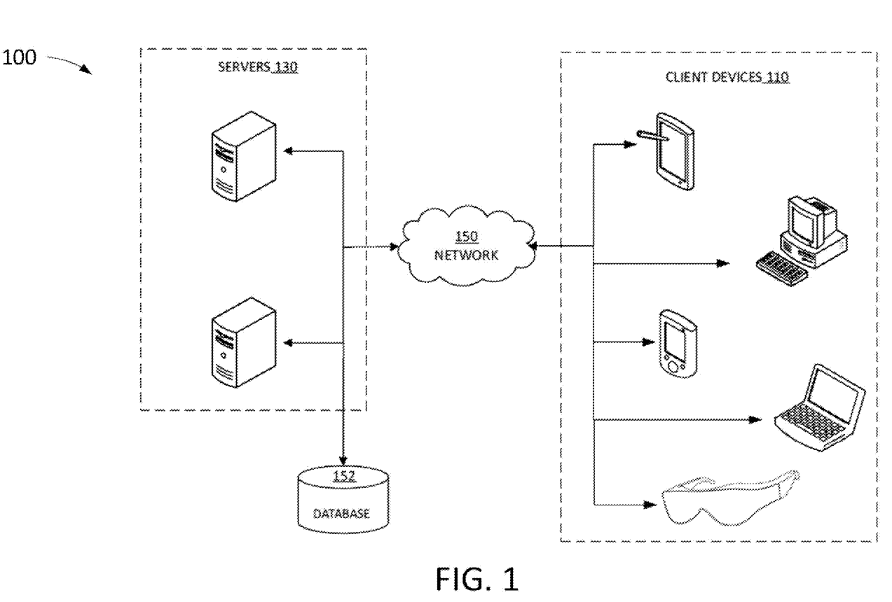

FIG. 1 illustrates a network architecture used to implement some aspects of the subject technology.

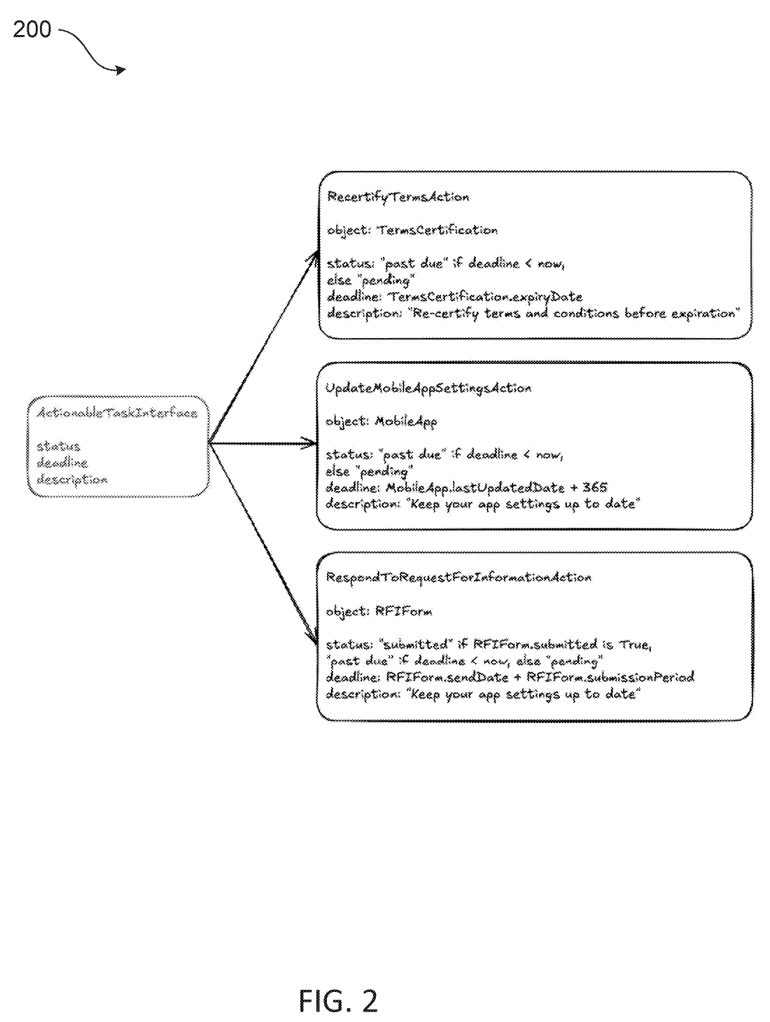

FIG. 2 is a diagram illustrating an example of an actionable task interface, in accordance with some aspects of the subject technology.

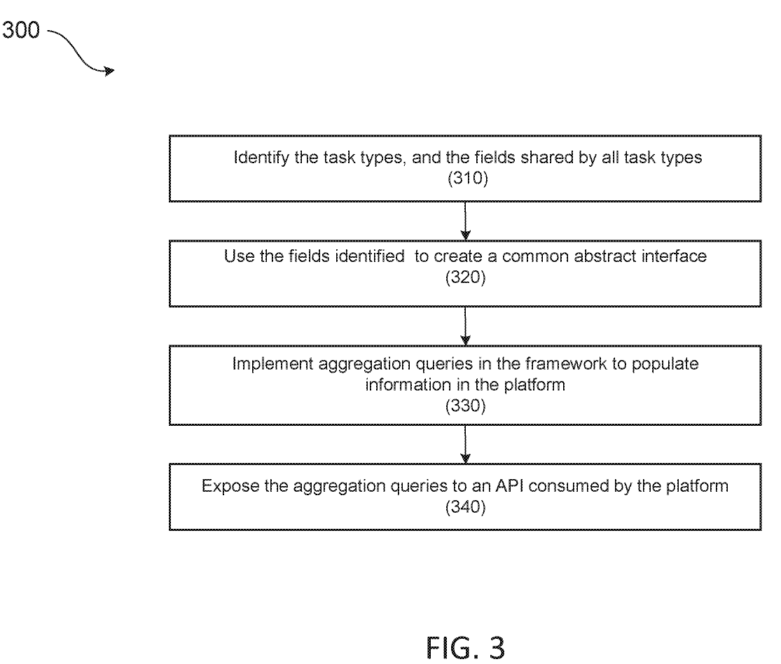

FIG. 3 is a flow diagram illustrating an example of implementation steps of a unified framework for object-backed actionable tasks assigned to users, in accordance with some aspects of the subject technology.

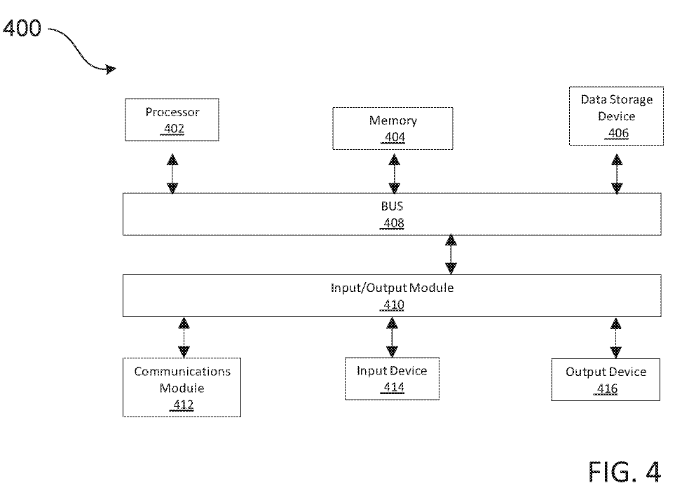

FIG. 4 is a block diagram illustrating an exemplary computer system within which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

The subject disclosure is directed to a unified framework for object-backed actionable tasks assigned to users. The subject technology relies on a common interface shared by all tasks and an associated object type for each task, which are implemented in a number of steps, as discussed herein. User assigned tasks generally require a user to complete a specific action and are intended to fulfill some requirement needed for the operation of the platform and/or to evaluate whether the user should have continued access to the platform.

Depending on the nature of the platform, these tasks will have an associated object (e.g., an advertisement (ad) campaign, a mobile application, a hardware device and the like) representing the requirement. To provide the user with information necessary to complete the task, the platform needs to interface with this object and compute the current status of the task. The provided information may include, but is not limited to, a deadline, a completion status, results from submission review, currently pending actions, and possible sanctions due to missing the deadline.

For large scale platforms, there can be different types of tasks covering different types of objects or combinations of objects. For such platforms, the existing technique is to implement object-specific logic to show actionable task information in the user interface. Furthermore, the platform may need to show different subsets of task information in different sections of the user interface (e.g., show a deadline and a short description in a homepage or show additional information in a subpage). This is generally handled by having multiple interfaces for each object type, which are then utilized by the corresponding sections of the user interface.

The existing technology suffers from several issues including the following four issues. 1) Having multiple interfaces for each object type can cause inconsistent information being shown to users, which may lead to privacy/compliance risks and revenue loss to the platform due to legal challenges and user attrition. For example, an ad campaign is incorrectly deactivated due to the wrong deadline being shown, making the ad creator believe they still had more time to take action. 2) Any time a new object type is created, additional work must be done to develop a new interface between the platform and the object type to handle actionable tasks. 3) Changing the internal logic of an object can lead to inconsistencies and/or failures in the interface and may potentially impact or even break the platform consuming this interface. This is especially a problem if the object and the platform are owned by different product teams. 4) Difficulties in distinguishing between actionable tasks, for example, users may often want to follow up or reference a specific actionable task, which is not straightforward when multiple tasks of the same type are assigned to the user. Typically, this would require implementing a unique numbering system specific to the tasks.

The subject disclosure relies of two concepts. The first concept is sharing a common interface by all task types. This interface defines the fields that are shared by all task types. Example fields include deadline, completion status, results from submission review, task description, task owner, etc. The interface is abstract and does not provide an implementation for the fields. The second concept is related to an associated object type for each task type. Each actionable task instance has a unique associated object attached to it, which is used to compute task metadata.

User assigned actionable tasks are a common design pattern in large scale platforms, and a streamlined framework to manage tasks would be highly beneficial from a user experience perspective. For instance, some companies have received a considerable number of support requests from developers due to confusion caused by actionable task information, such as inconsistent task deadlines, phantom tasks, delayed communication, etc., which can cause a waste of support resources and revenue loss due to developer unsatisfaction.

Turning now to the figures, FIG. 1 is a schematic diagram illustrating an example network architecture 100 within which some aspects of the subject technology are implemented. The network architecture 100 may include one or more servers 130 and a database 152, communicatively coupled with one or more client devices 110 via a network 150. The network 150 may include a wired network (e.g., via fiber optic or copper wire, telephone lines, and the like) and/or a wireless network (e.g., a satellite network, a cellular network, radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, a laptop computer, a desktop computer, or a mobile device such as a smart phone, a palm device, a tablet device, a television, a wearable device, a display device, and/or the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be a computing device such as part of a cloud computing server including one or more desktop computers or panels mounted on racks, and/or the like. The panels may include processing boards and also switchboards, routers, and other network devices. In some embodiments, the servers 130 may include the client devices 110 as well, such that they are peers.

One or more of servers 130 may be communicatively coupled to a database 152. Database 152 may store data and files associated with the servers 130 and/or the client devices 110. In some embodiments, client devices 110 collect data, including but not limited to video and images, for upload to servers 130, to store in the database 152.

FIG. 2 is a diagram illustrating an example of an actionable task interface 200, in accordance with some aspects of the subject technology. The diagram in FIG. 2 outlines the status, deadline, and description of various actionable tasks. A detailed description of each element is provided in the following. The first task is a terms certification where a status is set to “past due” if the deadline is before the current date; otherwise, it is “pending.” The deadline for this task is determined by the expiration date of the terms certification. The description of the first task indicates that the task requires re-certifying the terms and conditions before the expiration date.

The second task is a Mobile App Update where the status is set to “past due” if the deadline is before the current date; otherwise, it is “pending.” The deadline for this task is one year (365 days) after the last update date of the mobile app. The description of the second task indicates that the task involves keeping the app settings up to date.

The third task is an RFP Form Submission, where the status is “submitted” if the RFP form submission is true; otherwise, it is “past due” if the deadline is before the current date, or “pending.” The deadline for this task is calculated as the send date of the RFP form plus the submission period. The description of the third task indicates that the task involves keeping the app settings up to date.

These tasks are designed to ensure that users complete necessary actions within specified timeframes, maintaining the platform’s operational requirements and evaluating user compliance.

FIG. 3 is a flow diagram illustrating an example of implementation steps 300 of a unified framework for object-backed actionable tasks assigned to users, in accordance with some aspects of the subject technology. As described above, the subject disclosure relies on two concepts. The first concept is sharing a common interface by all task types, and the second concept is related to an associated object type for each task type. The implementation steps 300 for these tasks include steps 310 through 340, as described herein.

In step 310, the task types are identified, and the fields are shared by all task types. The fields include identification (ID), deadline, and status, but may include other fields.

In step 320, the fields identified in step 310 are used to create a common abstract interface. For each task type, the following steps are implemented. 1) Identify the associated object type that will back the task type. For example, a task that requires users to update settings for their mobile app would have “MobileApp” as the object type. The union of object types used for the framework has globally unique ID numbering. 2) Define when an action is actually necessary based on the object. If an action is not required, the implementation would return null for the task. Each object should have at most one task at any given time. 3) Create an implementation of the interface as follows: a) The ID of the task is the same as the ID of the object; b) The deadline of the task is tied to a defined time-based property of the object (for example, in the mobile app example, this may be computed as 365 days from the last updated date); c) The status is tied to the deadline, and optionally submission status/review status if these are defined fields. 4) If submission status is not defined, the task has two states: a “past due” if the deadline has passed; or a “pending” status if otherwise. 5) If submission status is defined but the review status is not, the task has three states: a) “submitted” if submission status is submitted; b) “past due” if submission status is not submitted and the deadline has passed; and c) “pending” if otherwise. 6) If both submission status and review status are defined, the task has four states: a) “completed” if submission status is Submitted but review status is Complete; b) “submitted/in review” if submission status is Submitted but review status is Incomplete; c) “past due” if submission status is not Submitted and the deadline has passed; and d) “pending” if otherwise.

In step 330, aggregation queries are implemented in the framework to populate information in the platform. To fetch all actionable tasks for a given user: a) Fetch all object types associated with a task type; b) Query objects that are owned by the user; c) Use the implementation used in the previous step to generate the actionable task for each object (note that the generated task may be null); d) Concatenate the tasks into a list, filter out nulls, and return; and e) Implement other aggregation queries as needed for the platform. For example, if the platform supports a “business” object with multiple users, all tasks for the business can be generated by fetching all actions for each user, concatenating, and filtering out duplicates.

In step 340, the aggregation queries are exposed to an application program interface (API) consumed by the platform. These queries would take an object as input and return the list of tasks associated with the object. An example implementation with an interface and three classes was shown in FIG. 2. The ID field, however, is not shown in FIG. 2, as the implementation is well-defined.

FIG. 4 is a block diagram illustrating an exemplary computer system 400 with which aspects of the subject technology can be implemented. In certain aspects, the computer system 400 may be implemented using hardware or a combination of software and hardware, either in a dedicated server, integrated into another entity, or distributed across multiple entities.

Computer system 400 (e.g., server and/or client) includes a bus 408 or other communication mechanism for communicating information, and a processor 402 coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer-readable medium for execution by, or to control the operation of, the computer system 400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 416 include display devices such as an LCD (liquid crystal display) monitor, for displaying information to the user.

According to one aspect of the present disclosure, the above-described implementation steps 300 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in the main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 400 reads application data and provides an application, information may be read from the application data and stored in a memory device, such as the memory 404. Additionally, data from the memory 404 servers accessed via a network, the bus 408, or the data storage 406 may be read and loaded into the memory 404. Although data is described as being found in the memory 404, it will be understood that data does not have to be stored in the memory 404 and may be stored in other memory accessible to the processor 402 or distributed among several media, such as the data storage 406.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

In conclusion, the disclosed subject technology directed is to a unified framework for object-backed actionable tasks assigned to users. The subject technology relies on a common interface shared by all tasks and an associated object type for each task, which are implemented in several steps.

In some aspects, the task types are identified, and the fields are shared by all task types.

In one or more aspects, the identified fields are used to create a common abstract interface.

In some aspects, the aggregation queries are implemented in the framework to populate information in the platform.

In one or more aspects, the aggregation queries are exposed to an API consumed by the platform.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable

results. As one example, the processes depicted in the accompanying figures do not necessarily require the particular order shown, or sequential order, to achieve desirable results. In certain circumstances, multitasking and parallel processing may be advantageous.

1. A method comprising:
identifying, by one or more computer processors coupled to memory, a task type and a task field associated with the task type;
generating a common abstract interface using the identified task type and task field;
implementing aggregation queries in a framework;
populating the aggregation queries; and
providing access to the aggregation queries to an API consumed by the platform.
